(19) United States
(12) Patent Application Publication
(10) Pub. No.: US 2014/0267754 A1
(43) Pub. Date: Sep. 18, 2014

(54) Method for applying a security marking to an object and a hyper-spectral imaging reader

(71) Applicant: LUXTREME LIMITED, Wan Chai (HK)

(72) Inventors: Juha Rantala, Hong Kong (HK); Pekka Katila, Hong Kong (HK)

(21) Appl. No.: 13/833,630

(22) Filed: Mar. 15, 2013

(51) Int. Cl. B42D 15/00; G06K 9/00

(52) U.S. Cl. CPC B42D 15/0013; G06K 9/00442
USPC 348/162; 283/85; 283/67

(57) ABSTRACT

Provided is a method for applying a security marking to an object and a hyper-spectral imaging device to readout the embedded information in the security marking to verify the object's authenticity. The present invention relates generally to the field of security markings and anti-counterfeiting technologies. More particularly to optical product authentication methods, which are based on photoactive nanoparticles emitting in visible and near-infrared wavelengths when excited with ultra violet or near infrared light.

### FIELD OF INVENTION

The present invention relates generally to the field of security markings and anti-counterfeiting technologies. The invention relates particularly to optical product authentication methods, which are based on photoactive nanoparticles emitting in visible and near-infrared wavelengths when excited with ultra violet or near infrared light. More particularly, embodiments of the present invention relate to invisible object coding and methods for optically reading out the security marking and verifying the object's authenticity. The present invention describes a method for applying a security marking to an object and a hyper-spectral imaging device to readout the embedded information in the security marking to verify the object's authenticity.

### BACKGROUND OF INVENTION

Companies and consumers worldwide are troubled by counterfeited and pirated products. Original manufacturers suffer tremendous financial losses and sullying of their reputation, while end-users are exposed to malfunctioning, non-reliable and even dangerous products. For individual consumers, the issue of verifying the manufacturer is particularly challenging when considering e.g. pharmaceuticals. For enterprises, there are many markets that would benefit from reliable methods to reveal counterfeited products, e.g. an electronic equipment manufacturer could benefit from such system by being able to guarantee that the subcomponents are all from an original source. Another field of interest is with high valued unique items that could carry sophisticated markings so that, e.g. in case of item transaction or purchase, the originality of an object could be easily verified. Such items could be e.g. unique objects of art or precious museum pieces.

There are several existing techniques and methods to identify and verify an original manufacturer. The present invention endeavours to solve issues related to counterfeiting and original product authentication by introducing a new method and equipment to verify the originality of the item, product or the product package. Current methods of applying e.g. so called quick response (QR) 2D codes or conventional 1D barcodes, which are mainly meant to share retail product information, are not sufficiently secure to be used for anti-counterfeiting purposes. Visible barcodes (1D or 2D) can be easily digitally imaged and copied or faked by a pirate manufacturer by relatively simple techniques. Typically these codes are generated with known algorithms and their information content can be machine readout and/or easily encoded with publicly available information. They can be easily counterfeited due to their size, visibility and the underlying conventional publicly known technology.

Holographic labels provide means to verify product authenticity with the naked eye. However, one distinct shortcoming of such holographic labels is that they are not unique for each product due to the nature of manufacturing method. Furthermore, this type of label could be detached and re-attached e.g. if applied on solid objects and thus a counterfeited object could be presented as genuine.

Invisible ink solutions can be spoofed because the spectral characteristics are not protected by complexity of the ink(s) and related spectral properties and/or the tag's emission is recognised with the naked eye only or the tag's emission can be analysed with equipment with a coarse spectral resolution. One invisible ultra-violet (UV) ink approach is based on random 2D pattern [Chong: Anti-Counterfeiting with a Random Pattern, Emerging Security Information, Systems and Technologies, 2008. Second International Conference on Cheun Ngen Chong et al. p. 146-153]. However, this approach may have drawbacks as it requires code retrieval at a manufacturing site for digital encoding i.e. a physical label is printed prior to digital code generation and it implies a method to produce unique random patterns time after time. Furthermore, imaging of scattering particles is a clear shortcoming of this approach, as is the possibility of too low a contrast of the label that may prevent reliable readout.

Another protection method is based on optically scanning the printed label on the surface of the product itself such as a box of a drug or pharmaceutical. However, this approach requires attaching the label on the surface of the object. Generally the complexity of an optical scanning system makes this type of approach less attractive.

One technical issue of existing concepts applying optical security labels is the complexity of readout equipment. Current state of the devices apply typically e.g. laser scanning [BayerTech]. One invention [Inksure: US2003002029] describes a spectrally identifiable tag but this invention is limited to a single dot without an imaging type compact hyper-spectral reader. Another invention [Wildey: US2007023521] applies a spectrally identifiable tag but describes a readout circuitry without imaging hyper-spectral capability as it is based on a photomultiplier tube, which is inherently non-imaging, or has very coarse imaging capability. Another invention [McGrew: US6692031] describes a method of applying spectrally identifiable tag and readout based on a diffractive grating and producing spectral dispersion on a line array, and thus the method is limited by speed and efficiency as the label must be scanned region by region and the signal then measured from each region in a serial fashion.

Another invention [BP: EP1793329] applies multicoloured tags and hyper-spectral recognition of the tag's emission. However, the described apparatus is based on scanning and fibre optics coupled with diffraction grating and 1D CCD element, and is thus not particularly compact.

The present invention is intended to address the aforementioned problems and shortcomings by introducing a concept based on a compact, invisible marking directly printable on the object surface, and a hyper-spectral imaging device able to read out the spectrally and spatially coded information embedded in the marking, optionally in a snapshot manner.

The method applies several techniques that are combined to enhance the security and to prevent circumvention of the marking. This method is highly secure, based on ink-jet tag printing of customised photoactive nanoparticles that are invisible to the naked eye, and a snapshot camera capable of hyper-spectral imaging. The manufacturing of the security marking can be fully automated and the verification step can be handled by an autonomic machine vision system.

### SUMMARY OF INVENTION

According to an aspect of the invention, there is provided a method of applying a security marking to an object, the method including printing at least one security ink directly onto the object, the security ink including at least one photoactive material having predetermined spectrally encoded characteristics.

The term “spectrally encoded characteristics” may include uniquely identifiable excitation and emission characteristics. More specifically, excitation and emission may be at certain unique predefined wavelengths

The term “object” may include any practicable physical object and may be an article of interest or packaging around an article of interest.

The security ink, when not excited, may be transparent/invisible to a human eye. In other words, the security ink may have no or negligible emissions in the optical frequency spectrum unless excited. The photoactive material may have emission in visible wavelengths between 400 and 700 nm when excited with UV or IR (infra-red) light. The photoactive material may have emission in near infrared wavelengths between 650 and 950 nm when excited with UV or IR light.

The security ink may include a plurality of photoactive materials, with each photoactive material having its own predetermined spectrally encoded characteristics. In this fashion, the security ink may include a combination of spectrally encoded characteristics realised by the individual characteristics of the plurality of photoactive materials. For example, there may be two to six, or even more, photoactive materials in the security ink. (The ink may be readable with a hyper-spectral device—further defined below). The spectral characteristics can be an emission peak or peaks providing unique light signals which can be separated from the spectra. Security can be enhanced by applying multiple security inks and using accurately defined ratios of emission peaks in the security code.

Instead, or in addition, the method may include printing a plurality of security inks respectively including one or more different photoactive materials. The respective security inks may be separate (e.g. adjacent) from one another and/or in contact (e.g. in layers) with one another.

The photoactive material(s) in the security ink may be based on nanoparticles or quantum dots, which have tailored, custom-made excitation and emission characteristics. In general, the optical emission of these nanoparticles-based materials typically has very narrow bandwidth and depends on nanoparticles-composition and size. Typical emission Full Width Half Maximum (FWHM) is 25 to 35 nm. The optical emission may be activated by exciting the nanoparticles with UV light in case of down-conversion nanoparticles or with IR light in case of up-conversion nanoparticles. Photoactive material can have such characteristics that optical emission intensity and spectrum depends on the light pulse length or intensity.

Furthermore, both types of materials, down-conversion and up-conversion, may be used in combination to make the emission spectrum even more distinct and more difficult to reproduce, thereby to enhance security further. Security may be further increased with a higher number of photoactive materials. Considering the current state of inkjet printer technology, the Applicant believes that a combination of four to five photoactive materials may be most practical.

The security marking may be printed in the form of at least one microdot. The security ink may be printed in the form of a plurality of microdots, e.g. an array of microdots. The array may be arranged in an ordered fashion, e.g. a matrix of rows and columns. The array may also be considered as an image with features formed of microdots. Thus, in addition to spectrally encoded characteristics, the security marking may include spatially encoded characteristics. This may be referred to as a physical code. Different security ink (or at least security ink having different photoactive material(s)) may be used for respective microdots in the array. The physical size of the array may be from a few square micrometers to tens of square millimetres. The dimension of microdot array, i.e. number of microdots in the array, may define the amount of spatial information content. The microdots may be regular (e.g. circular or rectangular) or irregular in shape.

The printing may be done by an ink-jet printer (or other type of printer operable to apply ink to an object). The ink-jet printer may be a conventional printer, e.g. an industrial ink-jet printer, not requiring special hardware adaptation or modification for use in accordance with the method.

The security ink may include a carrier to facilitate printing thereof. The carrier may be, or may include, an ultra-violet curable resin. The carrier may permit the photoactive material to be printed and may provide a solid matrix to bind the photoactive material in the security marking. The resin may be any fluid material with suitable material parameters for printing and may be e.g. acrylic or epoxy-based material. The method may therefore include the prior step of mixing the security ink to include at least one photoactive material and a carrier.

The method may include the step of curing the security ink, e.g. by applying ultra-violet light thereto. After curing, the carrier may be in stable and transparent form to allow photo activation and emission output for readout. Furthermore, the carrier may provide an adhesion layer and protection against humidity and mechanical wear out. Viscosity of the carrier may be below 100 mPas and may be 10-20 mPas. Suitable surface tension for the carrier may be within 10-100 mN/m (25° C.), and may be within a range of 30 to 40 mN/m (25° C.).

The method may include loading the photoactive material in an organic solvent such as toluene, chloroform or other suitable solvent that can be used as a temporary carrier before mixing nanoparticles into the final carrier. Other temporary carriers may be used as well and direct mixing of nanoparticles from powder form may also be practicable.

The method may include:
generating a digital code; and
mixing (or otherwise creating) at least one security ink embodying a physical code which is representative of the digital code.

The invention extends to a security marking which includes at least one security ink including at least one photoactive material having predetermined spectrally encoded characteristics.

The invention also extends to an object having applied thereto a security marking as defined above. The object may have the security marking applied thereto in accordance with the method defined above.

According to another aspect of the invention, there is provided a method of reading a security marking applied to an object, the security marking including at least one photoactive material having predetermined spectrally encoded characteristics, the method including:
applying a light pulse to the security marking, thereby to excite the photoactive material; and
measuring emission characteristics from the excited photoactive material, thereby to read a physical code from the security marking.

The method may include varying an intensity and spectrum of the light (optical) pulse to excite or activate different characteristics in the photoactive material(s). The method may include varying the duration or period of the light pulse (e.g. snapshot or continuous).

The measuring may be delayed relative to the application of the light pulse thereby to measure time-dependent emission characteristics.

The method may include decoding the measured emission characteristics thereby to generate a digital code. The method may include comparing the digital code against a code database, thereby to identify the security marking and hence the object to which it is applied.

The method may include reading the security marking by use of an electronic device.

The invention extends further to a hyper-spectral device (further referred to as a reader) operable to read a security marking on an object, the reader including:
a light source operable to apply an excitation pulse to the security marking; and
an image sensor operable to sense or measure the emission characteristics of the security marking in response to excitation thereof.

The light source may include a UV LED, which may have an emission wavelength of 400 nm or less. The light source may include a UV laser diode, which may have an emission wavelength of 405 nm or less. The light source may include an IR laser source. The IR laser source may have a single emission wavelength (e.g. 980 nm) or multiple emission wavelengths (e.g. 780, 808 and 980 nm).

The reader may include a diffractive optical element (DOE) in combination with the excitation light source to have a flat-top intensity profile.

The device may include control electronics operable to communicate the measured emission characteristics to a computer or other electronic device for processing, e.g. for comparing against a pre-populated code database.

### BRIEF DESCRIPTION OF DRAWINGS

The invention will now be further described, by way of non-limiting example, with reference to the accompanying diagrammatic drawings.

In the drawings:

FIG. 1 shows a schematic view of a microdot array forming the security marking according to an embodiment of the present invention.

FIG. 2 shows a flow diagram of an example method of applying a security marking according to an embodiment of the present invention.

FIG. 3 shows a flow diagram showing more detail of a step of the method of FIG. 2.

FIG. 4 shows a flow diagram of an example method of reading a security marking according to an embodiment of the present invention.

FIG. 5 shows a schematic view of a reader according to an embodiment of the present invention.

FIG. 6 shows a wavelength spectrum of a tunable filter of transmission channels of the reader of FIG. 5, shown with a typical set of emission peaks from typical nanoparticles used in a security marking.

### DETAILED DESCRIPTION OF EXEMPLARY EMBODIMENT

The following description is merely a non-limiting example and it will be appreciated by one skilled in the art that specific details of the example may be changed without departing from the spirit of the invention.

It is desired to mark an object with a security marking for a number of possible reasons but particularly to identify the object reliably and to verify the origin and authenticity of the object. The object may be a valuable article (e.g. a mobile phone) or may be packaging of a sensitive article (e.g. pharmaceutical tablets). In this example, the object is the valuable article itself which is sufficiently robust to receive ink printed from an ink-jet printer.

The security marking comprises security ink having at least one photoactive material with predetermined spectrally encoded characteristics. The photoactive material is in the form of various types of available nanoparticles having various spectral characteristics. In this example, the security marking is in the physical form of an ordered array of microdots. The specific ordering of the microdots and composition of the security ink may be a question of design preference and coding requirements.

FIG. 1 shows a 10×10 matrix of microdots 102 constituting an example security marking 100. If each microdot 102 could merely have or not have a single type of nanoparticle 104 (i.e. a binary value), there could be 100 bits (about 12.5 bytes) of data. However, by including a combination of, say, four types of nanoparticles 104, each dot 102 could have 1 of 16 (2̂4) values, the security marking 100 thus capable of representing nearly 200 bytes of data which is more than enough to convey a serial number which is typically 10-20 digits long. The extra data may be used for error correction, date/time stamps, to provide redundancy for rotational symmetry so that the security marking may be read from various orientations, etc., or may not be used at all.

The security marking 100 is applied in accordance with a method 200 as illustrated in FIG. 2. First, the source security inks are formed (at block 202) by mixing various resins (acting as carriers) with the desired nanoparticle combinations with selected excitation and emission characteristics. For instance, if four different nanoparticles are used, one design option is to mix 15 different batches of security inks, each for a different combination of the nanoparticles. In such case, any microdot 102 could be printed from a single ink only. Instead, four security inks may be mixed, each with a single type of nanoparticle only. Then, to print a microdot 102 having a combination of types of nanoparticles, a plurality of inks would be used, in similar fashion to how a colour ink-jet printer renders various colours by combining black/cyan/magenta/yellow. With this option, fewer inks and associated ink reservoir would be required.

In this example, the carrier is a UV curable resin that provides the required liquid carrier for ink jetprinting and a solid matrix to bind the nanoparticles 104 in a microdot 102. The curable resin has suitable optical properties when hardened to allow transmission of excitation and emission light from the securing marking. A typical security ink for ink-jetting is a mixture of UV curable polymer and toluene based solution of nanoparticles. An example required concentration of nanoparticles in toluene can be between 0.1 to 5 mg/mL resulting with nanoparticle mass concentration of 0.005% to 0.1% in prepared security ink. Such concentrations do not change the ink-jetting parameters.

Whichever ink option is selected, the ink-jet printer (not illustrated) is then charged (at block 204) with the various inks carrying their respective nanoparticle(s) 104.

It is then determined (at block 206) how the security marking should be configured. In other words, a physical code (Uₚ) is determined which is representative of a digital code (U_{d}). This determination may be done locally (e.g. by a print server connected to the ink-jet printer) or remotely (e.g. by a security server) and then communicated to the printer.

FIG. 3 shows sub-method steps associated with step 206 of FIG. 2. First, information is gathered (at block 302) about the object to be marked, e.g. owner, part number, etc. If desired, additional information, e.g. date/time, serial number, etc. is appended to the object information thereby to generate (at block 304) the digital code (U_{d}). The digital code (U_{d}) is a unique code used to identify the object uniquely.

Information relating to the particular security ink configuration is then shared/gathered (at block 306) so that the physical code (Uₚ) can be generated (at block 308). In other words, the physical code (Uₚ) defines how the security marking 100 should be configured to be representative of the digital code (U_{d}). The codes (U_{d} and Uₚ) are linked with each other and saved (at block 310) in a code database (not illustrated) for later retrieval. Once the physical code (Uₚ) has been defined, it is communicated to the printer for application to the object.

The object is aligned (at block 208) with the printer. It will be appreciated that the aligned and subsequent printing may be largely automated, e.g. being part of a production line.

The printer then applies the security marking to the object by printing (at block 210) the security inks directly onto the object in accordance with the generated physical code (Uₚ). Again, in this example, the security marking 100 is as illustrated in FIG. 1, being an array of round microdots 102, each having a specifically defined combination of nanoparticles.

More specifically, the security ink (in the form of UV curable polymer material that contains the photoactive nanomaterials) can be printed with minuscule drops onto the object's surface, such as glass, ceramic, paper, metal, plastic or other solid material. Typical ink-jetting volumes are in range of 1 to 20 pL to form microdots 102 in a size of 10 to 100 μm in diameter. The described security ink and a 10 pL ink-jet nozzle head can result a printing resolution of 300 dpi. A distance between adjacent microdots can be negligible but should not exceed e.g. 100 μm in the case of a 1×1 mm² sized array of e.g. dimension (M), preferably of at least 10×10 microdots 102.

The size of the microdot array 100 may be influenced by an intended reading distance. It can potentially be relatively large in case the reader is located far enough from the object and is equipped with suitable optics and excitation light. However, a very small size marking 100, below 1×1 mm², is useful to make the excitation more efficient and readout more reliable. A small sized microdot array 100 is also useful in case the object has no large surfaces with smooth areas. Also, a symmetric microdot array 100 allows easier readout as there is no requirement to rotate the reader with respect to the microdot array 100. However, in other embodiments, certain asymmetry may be preferable to allow identification of orientation of the security marking 100. This asymmetry can be coded in spatially or spectrally into the security marking 100. Very large microdot arrays (i.e. matrices with larger dimensions) provide effective means for including error coding. Thus the code would be less sensitive to overlaying dust and particles weakening signal emission.

The freshly-printed security marking 100 is cured (at block 212) by applying UV radiation (e.g. using a UV light source) thereby to harden the ink and stabilise the marking 100. The method 200 could terminate at block 212. Optionally, the method 200 may include the further steps of reading (at block 214) the printed physical code (Uₚ′) and comparing (at block 216) this with the original physical code (Uₚ) as stored in the code database thereby to verify the integrity and readability of the printing. (Similarly, the digital code (U_{d}′) may be decoded from the read physical code (Uₚ′) and then compared against the original digital code (U_{d}) to verify decoding integrity.) This reading may be done as described below.

FIG. 4 illustrates a method 400 for reading a security marking 100 while FIG. 5 illustrates an associated reader 500 for use in accordance with the method 400. However, it will be appreciated that the method 400 may be realised by a differently configured device while the reader 500 could be configured to perform a different method. The reader 500 is a hyper-spectral imaging device which can read out the full microdot array 100 located within an area of roughly 1×1 mm². For a microdot array 100 of this size, the reader 500 may need to be 1-50 mm away

The reader 500 comprises an integrated light source 502, imaging optics 503, tunable optical filter 504, fixed optical filter 505, CMOS image sensor 506, electronic control unit 507 and communication interface 508 such as a USB port. The integrated light source 502 is based on LEDs operating at appropriate UV wavelengths. In some embodiments, it is appropriate to have laser diodes as light sources operating at near UV or UV wavelengths e.g. 405 nm or at near infra-red wavelengths e.g. 980 nm. The imaging optics 503 are designed to image at least an area similar in size to the microdot array 100, but preferably two or three times the area. The light collection efficiency of the device 500 is limiting to the area to be imaged.

The reader 500 is aligned (at block 502) with the security marking 100. The alignment may be automated, e.g. as part of a production line, or manual, e.g. barcode scanner-fashion if the reader 500 is shaped like a barcode gun. The light source 502 emits (at block 404) an excitation pulse thereby to illuminate the microdot array 100 and to excite the photoactive materials 104 and cause emission 501 therefrom at their associated spectral peaks. The emission 501 is read or collected (at block 406) via the imaging optics 503, thereby to read the physical code (Uₚ′). An optical path is defined from the imaging optics 503 via the filters 504, 505 to the sensor 506.

Depending on the light source 502, the fixed filter 505 may be a fixed long pass filter to remove excitation wavelengths in case of UV light, or a fixed short pass filter to remove IR excitation light. The optical path also includes the electronically tunable optical filter 504 to allow hyper-spectral imaging. A tunable miniaturised Fabry-Perot filter based on Micro Electro Mechanical System (MEMS) is used with appropriate tuning steps and speed to record image at required wavelengths. As a result, tens or hundreds of image frames can be stored to analyse the spectra of the emission originating from the microdot array 100. Spatial resolution of the imaging is determined by the imaging optics 503 and resolution and pixel size of the image sensor 506. A resolution of VGA or 1 Mpixel is preferred with 3 to 50 μm pixel size to reach a spatial resolution of 10 to 50 μm, in case of 1 to 4 mm² microdot array 100. Spectral resolution is determined by the tunable filter's finesse and contrast, and such characteristics can be expressed also in pass band FWHM value and free spectral range (FSR). A typical range of values for the FWHM parameter is 20 to 50 nm, while Free Spectral Range (FSR) is 60 to 120 nm. By providing FWHM of 20 nm and FSR of 80 nm, it is possible to identify emission spectra from four to six typical nanoparticle emission spectra falling within FSR as shown in FIG. 6.

The read physical code (Uₚ′) is decoded (at block 408) to produce the read digital code (U_{d}′). This may be done locally by the reader 500, e.g. by the electronic control unit 507 if suitably programmed. Instead, the read physical code (Uₚ′) may be communicated via the communication interface to a secure server (not illustrated) for decoding remotely. Once decoded, the read digital code (U_{d}′) is compared against the original digital code (U_{d}) thereby to verify (at block 410) the security marking. This comparison may be done by interrogating the code database to determine whether or not there is a match of the read digital code (U_{d}′) against any of the digital codes (U_{d}) in the code database. The associated description of the object can then be retrieved and accepted with a high degree of certainty to be an accurate description/identifier of the object.

The applicant believes that the invention as exemplified is beneficial in that it provides a method 200 of applying a secure marking 100 to a physical object. The object need not be specially modified for use with the method 200 and furthermore conventional ink-jet printing techniques may be employed.

The security marking 100 itself is highly secure and difficult to re-create/spoof. It may be impossible or at least prohibitively cumbersome to reproduce such a security marking 100. It is also difficult or impossible to modify the security marking 100 without further application of photoactive particles 104 having specific spectral characteristics. The combination or spectral and spatial coding is particularly secure. The security marking 100 (depending on the array size) can convey more data than conventional barcodes and may include a product description, timestamp, unique serial number, etc.

In addition, the reading of the security marking 100 cannot be done with the naked eye and indeed not even with conventional imaging equipment. A specially adapted reader 500 in accordance with the invention can read and verify the security marking.

In accordance with certain embodiments, it is an aspect that the security marking is an image that combines multiple photo emitters that can be excited with one or multiple light sources. In essence, a code is written within the security marking. The written code can vary based on the excitation source, e.g. the illumination source.

Additionally, according to certain embodiments, the security marking is read by detecting photo emitters within the security marking in a hyperspectral mode. For example, a hyperspectral imaging device can be used to read a security marking. The hyperspectral imaging device may comprise a tunable Fabry-Perot filter and an image sensor. Furthermore, the hyperspectral imaging device may comprise an array of image sensors each a having different spectral sensitivity range.

Still yet, the hyperspectral imaging device may comprise an image sensor, signal separator, micro-lens array and filter array. The filter array of a hyperspectral imaging device may have individual pass band filters with, for example, at least 50 nm wavelength resolution, or better.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A security marking comprising:
at least one area covered by a printed security ink containing at least one photoactive material or set of photoactive materials having a predetermined ratio of spectral peaks for a particular illumination source type.

2. A security marking in accordance with claim 1, wherein the predetermined ratio of spectral peaks contains at least two finite and distinct spectral peaks for a single illumination source type.

3. A security marking in accordance claim 1, wherein the at least one photoactive material or set of photoactive materials has at least a first predetermined ratio of spectral peaks for a first illumination source type and a second predetermined ratio of spectral peaks, distinct from said first predetermined ration, for a second illumination source type.

4. A security marking in accordance with claim 1, wherein said printed security ink contains at least two photoactive materials and said printed security ink has a predetermined ratio of at least two distinct spectral peaks for a particular illumination source type.

5. A security marking in accordance with claim 1, wherein at least a portion of said area is covered by a second printed security ink containing at least one photoactive material or set of photoactive materials having a distinct predetermined ratio of spectral peaks for a particular illumination source type.

6. A security marking in accordance with claim 5, wherein each overlapping printed security ink portion comprises a distinct physical layer.

7. A security marking in accordance with claim 5, wherein the overlapping printed security ink portions are not blended or mixed.

8. A security marking in accordance with claim 5, wherein said second printed security ink contains at least one photoactive material or set of photoactive materials having a predetermined ratio of spectral peaks for an illumination source type which is different from the first illumination source type.

9. A security marking in accordance with claim 1, wherein the predetermined ration of spectral peaks in the printed security ink is determined by a predetermined ratio of distinct nanoparticles within the security ink each having at least one known spectral peak for a particular illumination source type.

10. A security marking in accordance with claim 1, wherein the security ink contains a UV cured resin.

11. A security marking in accordance with claim 1, wherein the at least one area is a microdot.

12. A security marking in accordance with claim 1, wherein the security marking further comprises a set of distinct and non-overlapping areas each covered by at least one printed security ink containing at least one photoactive material or set of photoactive materials having a predetermined ration of spectral peaks for a particular illumination source.

13. A security marking in accordance with claim 12, wherein each of the distinct and non-overlapping areas is a microdot.

14. A security marking in accordance with claim 12, wherein the set of distinct and non-overlapping areas is arranged in a predetermined spatial manner.

15. A security marking in accordance with claim 14, wherein the predetermined spatial manner is an array having a predetermined spacing.

16. (canceled)

17. (canceled)

18. A method of reading a security marking comprising the steps of;
illuminating, with a first illumination source type, a security marking having at least one printed security ink containing at least one photo active material or set of photoactive materials having a predetermined ratio of spectral peaks for a first illumination source type,
measuring the spectral emission from the printed security ink of at least one pixel,
determining the ratio of spectral peaks of the at least one pixel for the first illumination source,
matching the determined ratio of spectral peaks to a database containing known predetermined ratios of spectral peaks for security inks illuminated by a first illumination source,
determining the presence of at least a portion of a security code based on said matching.

19. A method in accordance with claim 18, further comprising the steps of;
illuminating, with a second illumination source type, the security marking having at least one printed security ink containing at least one photo active material or set of photoactive materials having a predetermined ratio of spectral peaks for first and second illumination source types,
measuring the spectral emission from the printed security ink of the least one pixel,
determining the ratio of spectral peaks of the at least one pixel for the second illumination source,
matching the determined ratio of spectral peaks to a database containing known predetermined ratios of spectral peaks for security inks illuminated by a second illumination source,
determining the presence of at least a portion of a security code based on said matching of the determined ratios.

20. A method in accordance with claim 18, or further comprising the steps of;
measuring the spectral emissions from a plurality of pixels distributed over at least a portion of the security marking by at least one illumination source,
matching the determined ration of spectral peaks of each pixel to a database containing known predetermined ratios of spectral peaks for security inks illuminated by the at least one illumination source,
determining the presence of at least a portion of a security code based on said matching and the location of each respective pixel within the security marking.

21. (canceled)

22. (canceled)

23. (canceled)

24. A device for reading a security marking, said device comprising;
at least one illumination source,
a hyperspectral imaging device,
a database containing a set of predetermined ratios of spectral peaks for each illumination source type,
a computer readable medium having stored thereon a set of computer readable instructions for determining the ratio of spectral peaks measured by the hyperspectral imaging device of at least one pixel of a security marking which has been illuminated by the at least one illumination source, and which matches the determined ratio of spectral peaks to the database to determine the presence of at least a portion of a security code.

25. (canceled)

26. A device in accordance with claim wherein the hyperspectral imaging device comprises a tunable Fabry-Perot filter and an image sensor.

27. A device in accordance with claim 24, wherein the hyperspectral imaging device comprises an array of image sensors each a having different spectral sensitivity range.

28. A device in accordance with claim 24, wherein the hyperspectral imaging device comprises an image sensor, signal separator, micro-lens array and filter array.

29. A device in accordance with 28, wherein the filter array comprises individual pass band filters with at least 50 nm wavelength resolution.

30-57. (canceled)
